(19) United States
(12) Patent Application Publication
(10) Pub. No.: US 2008/0147482 A1
(43) Pub. Date: Jun. 19, 2008

(54) ADVERTISEMENT SELECTION AND PROPAGATION OF ADVERTISEMENTS WITHIN A SOCIAL NETWORK

(75) Inventors: Bill Messing, Seattle, WA (US); Michael Hyman, Bellevue, WA (US); Jeff Lehman, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: RIPL CORP., Seattle, WA (US)

(21) Appl. No.: 11/927,198

(22) Filed: Oct. 29, 2007

Related U.S. Application Data
(60) Provisional application No. 60/854,802, filed on Oct. 27, 2006.

(51) Int. Cl. G06Q 30/00

(52) U.S. Cl. 705/10

(57) ABSTRACT

In various embodiments, direct or indirect specification of an advertisement to be displayed on a web page or other medium being published or administered by a user is received by a computing device. In response, the computing device provides or enables provision of the advertisement to be delivered and displayed to another user that is a friend of the user, and/or another advertisement to be displayed subsequently to the user. In various embodiments, the computing device provides or enables provision of an advertisement to be displayed for the user based on the intersection of the preferences of the user with the preferences of a publisher or administrator of content being consumed by the user. In various embodiments, the computing device tracks propagation of an advertisement through a social network of users, and/or determining the nature and amount of influence a user has in propagating an advertisement through the social network.

### RELATED APPLICATIONS

The present non-provisional application claims priority to provisional application No. 60/854,802, entitled “Display of Contextual Advertising as a Form of User Generated Content”, filed Oct. 27, 2006.

### TECHNICAL FIELD

The present invention relates generally to the field of data processing. More specifically, the present invention relates to the selection and propagation of advertisements in a social network.

### BACKGROUND

With advances in computing, networking and related technologies, more and more computing devices are networked together, with more and more content available to the networked computing users. For example, billions of content pages/objects are available on the WWW for Internet users. However, publication and propagation of content in a relevant manner—that is, publishing and propagating content to those would be interested—remains a challenge.

For example, social networks on the Internet have become very popular in recent years. Social networks typically consist of two main elements: 1) users; and 2) the content within the network, such as home pages and images, that the users come to the network to view. For a network to become successful, it must attract users who will both produce and consume content. In the social networks that exist today, content is typically produced (i.e. published) by users using a traditional publishing approach. That is, when a user has something he or she decides to share, the user uses the social network system to create (publish) the content—for example by writing a blog entry, by uploading an image, or by rearranging his or her home page. This set of explicit actions lets a user construct a representation, available for others to view, of his or her personality and interests, or persona. This practice can be extended to reflect his or her interests in advertisements, advertisers, merchandise, and other commercial content. This approach allows for the display of a breadth of content, but it requires users to actively update their content in order to maintain the interest of viewers. Because updating content is labor-intensive for the publisher, sites typically have a very large difference between the number of people viewing and the number of people creating content, sometimes as much as 100:1. This means that the social network system must attract a very large number of people in order to have enough actively changing content to generate repeat traffic. Typically such social network systems have a large number of publishers who create an initial page and then rarely or never update it. Likewise, the abandonment rate of viewers is also often high. Viewers must be dedicated in order to find new and interesting content. Thus, increased automation in content publication and propagation in a relevant manner would be desirable. Based on the implicit or explicit interests of a user, the present invention automates the delivery and display of advertising and other commercial content to other people in the user's social network.

In a related field of endeavor, operators of network systems, including social networks, often support published content with advertisements. The rules by which such advertisements are inserted into published content are usually planned in advance by the operator, usually without the explicit input of either the publisher or the visitor to the published content—and with the implicit input of the visitor alone in the form of a response history to various advertisements. The present invention takes into account the implicit or explicit interests of the publisher in displaying advertisements to a visitor.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of content publication in a social network suitable for practicing the present invention;

FIG. 2 illustrates advertisement selection and propagation, in accordance with various embodiments of the present invention; and

FIG. 3 illustrates an example computer system suitable for use to practice various embodiments of the present invention.

### DETAILED DESCRIPTION OF ILLUSTRATIVE EMBODIMENTS

Illustrative embodiments of the present invention include, but are not limited to, methods and apparatuses for advertisement selection and propagation in a social network.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

The word “friend” may mean any person to whom a user is connected in a social network. A user in a social network may have many thousands of “friends” who he or she doesn't even know but who have chosen to affiliate with the user.

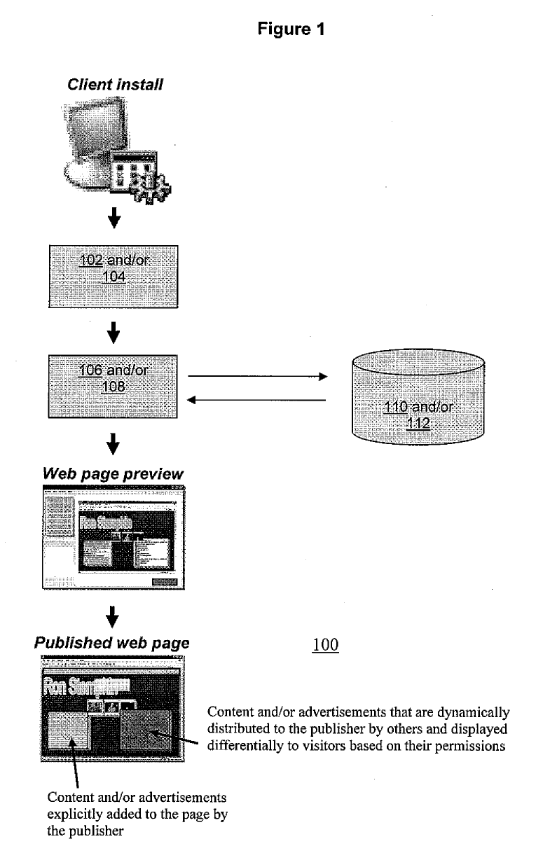

FIG. 1 illustrates an overview of content publication in a social network, suitable for practicing the present invention. The social network system 100, as illustrated, presents to each user of the system a set of constantly changing content that the user will likely find interesting. The content may originate within the system or from external sources available to the system. The content may be published substantially automatically, based upon a broad set of discovery methods. These methods, in various embodiments, may look at factors such as a person's social network, what music the members of the social network are listening to, how the members behave at one or more web sites, and so forth. These discovery methods may be designed to require relatively little action on behalf of the user; the user just needs to have friends that are also members of the social network. This social network could be embodied via a web site or via some other electronic mechanism. We will refer to the electronic mechanism by which the users interact as the “social network.” The members will ideally listen to music or take photographs or browse through the social network. All of these are considered natural actions for users of the system. From the simple act of having friends and occasionally (or better yet frequently) interacting with the social network, the system is able to provide a constantly changing set of content. This content, in various embodiments, is delivered directly to the user's desktop in addition to their home page on the social network. Although it is natural for the social network embodiment to be delivered via a web site, in alternate embodiments the content may be delivered to other devices of the user—such as the user's personal digital assistant, cell phone, portable media player and so forth.

Additionally, as will be described in more detail below, users may explicitly select advertisements for display along with the content they produce or consume, in the same or a concurrently displayed web site/electronic mechanism. Users may select a specific advertisement, or indirectly select an advertisement by selecting a specific advertiser, or a category of advertisements. Additional advertisements may be automatically selected for the user, either based on the user's or his friends' explicit selections or algorithmically determined user preferences, and in particular their intersection.

The social networking system of the present invention combines this constantly changing content with another innovation: the system exposes what the system is delivering to a person's desktop to anyone who visits the person's home page. For example, suppose that the system is showing user A content items 1, 2 and 3 on A's desktop. These items appear on user A's desktop as well as on user A's home page on the social network. If visitor B goes to user A's home page, visitor B will also see content items 1, 2 and 3.

Suppose then that as user A interacts with incoming content, the system changes the content user A sees to content items 1, 5, and 10. When user B goes to user A's home page, user B will also see items 1, 5 and 10.

Thus, user A's persona page is constantly changing simply by the act of user A having had minimal interactions with content on the social network. What this means is a complete shift of the typical viewer-participant ratio. Everyone using the social network is a participant and is acting as a discovery engine that others can see.

In various embodiments, the content that is shown to user B is processed through a set of permissions filters before being displayed. For example, suppose that content item 1 is marked as only visible for user A. The system will show items 1, 5 and 10 to user A. When user B visits user A's page on the social network, however, the system will only display items 5 and 10.

In various embodiments, the system may be endowed with several services:
A Content Selection Service 102 for selecting material to display to the user based on social network activity, which is also referred to as Relevant Content Service.
An Advertisement Selection Service 104 for selecting advertisements that are published and/or viewed by a specific user, may also be referred to as Relevant Advertisement Service
A Rights Filtering Service 106
A Content Merging Service 108
A Content Metadata Store 110
A Content Store 112

In various embodiments, the Relevant Content Service 102 is designed to accept a user ID as an input, and provide access to a content metadata store that provides information about all content in the system and all user interactions with that content. From that information, the Relevant Content Service 102 returns a set of content IDs that would potentially be of interest to the user, each of which has a relevance score associated with it.

In some embodiments, the Relevant Advertisement Service 104 may allow a publisher or visitor to explicitly determine one or more advertisements, or may automatically determine and include one or more advertisements for the publisher or visitor, either based on explicitly defined preferences or on preferences inferred about the user.

A publisher or visitor may explicitly determine advertisements in a number of ways. First, the publisher may select categories of advertisements to display to viewers of the published web site. In one embodiment, the publisher may do this by selecting a number of topics of interest, such as “snowboarding.” Such categories may be used as an explicit declaration of a preference, and may be used in conjunction with the automatic advertisement determination features of the Relevant Advertisement Service 104, described in great detail below. Second, the publisher may select specific advertisers whose advertisements the publisher would like to display to web site viewers. In one embodiment, the specific advertisers may be selected from a list of participating advertisers. Third, the publisher may select specific advertisements that the publisher would like to display to web site viewers. In one embodiment, the specific advertisements may be selected from a list of available advertisements.

In one embodiment, the Relevant Advertisement Service 104 may include a number of advertisements that the publisher may cycle through (i.e., have one display location used for multiple advertisements, the location having an associated mechanism for switching among the advertisements), with the last advertisement displayed constituting the publisher's selection. In one embodiment, the visitor to a published web page may enjoy the same ability as the publisher to determine what advertisements to display. In one embodiment, the publisher may select advertisements using any two or all three of the above approaches, or may use any other approach known in the art.

In addition to explicitly selecting advertisements or advertisement preferences, the Relevant Advertisement Service 104 may, in some embodiments, allow a publisher to select the format and location of the advertisement(s) within the publisher's web site. The format may comprise one of a number of standard advertisement sizes a publisher may select from among. In one embodiment, the publisher may determine the advertisement location using a drag-and-drop approach. In one embodiment, a visitor to a published web page may enjoy the same ability as the publisher to determine the size and location of an advertisement.

In various embodiments, the Relevant Advertisement Service 104 may also or instead automatically determine advertisements for a publisher. The Service may determine the advertisements in a number of ways.

First, the Service 104 may locate advertisements having some similarity of relevance to (i) keywords extracted from the publisher's web site, (ii) keywords the publisher has used to characterize him/herself within the system, or (iii) categories and/or advertisers the publisher has explicitly selected. For example, if the publisher has a number of lacrosse-related items of content included in the web site, the Relevant Advertisement Service 104 may find advertisements related to lacrosse.

Second, the Service 104 may locate advertisements having some similarity or relevance to keywords the viewer has used to characterize him/herself within the system, or if the viewer has a web site, keywords extracted from the viewer's website, or keywords derived by the system from the selections of advertisements and/or advertisers the viewer has made on the viewer's own pages. Thus, advertisements may be delivered that may be of interest to the viewer, but may have no association with the viewed web site. For example, the website may include equestrian-related content, and its advertisements may be related to knitting, because of the differing interests of the publisher and viewer.

Third, the Service 104 may locate advertisements based on some combination of the publisher's and viewer's keywords/interests. For example, if the publisher only has interests A, B, and C, and the viewer has interests C, D, and E, the Relevant Advertisement Service 104 may only seek to locate advertisements relevant to C. In locating/determining the advertisements, the Relevant Advertisement Service 104 may use methods similar to those used by the Relevant Content Service 102 in determining the content, discussed above.

In some embodiments, the Relevant Advertisement Service 104 may also track the viewer's interaction with the advertisements and may use that information to automatically determine further/different advertisements to display to the viewer.

Once selected whether by the user or by Service 104, Relevant Advertisement Service 104 facilitates propagating the selected advertisements to other content and/or users of the social network. In various embodiments, the advertisements selected by a user or other relevant advertisements in view of the selections may influence the selection of advertisements displayed for the user in connection with any or all subsequent content viewed by the user. In various embodiments, the advertisements selected by a user or other relevant advertisements in view of the selections may influence the selection of advertisements displayed in connection with the content published or administered by friends of the user, or for all subsequent content viewed by friends of the user. By selecting an advertisement for display to others, a publisher causes that advertisement to be distributed to and/or displayed to his or her friends.

In summary, in various embodiments, an advertisement to be displayed in a medium being published or administered by a user may be directly or indirectly specified. In response, the advertisement, other advertisements by the same advertiser, or advertisements related in other ways may be delivered to and/or displayed in connection with any content subsequently viewed by another user that is a friend of the user, and/or another advertisement to be selected and displayed with other content subsequently viewed by the user. In various embodiments, an advertisement may be displayed in connection with content viewed or consumed by a user based on the intersection of the preferences of the user with the preferences of the publisher or administrator of that content or medium.

In various embodiments, Service 104 may provide the advertisements to the user or enable an advertiser to provide the advertisements to the users. In various embodiments, Service 104 may also be configured to receive notification of a user's response to an advertisement. In response, Service 104 may further distribute or propagate the advertisement to friends of the user, based at least in part of the response. In various embodiments, Service 104 may also be configured to track propagation of an advertisement through a social network of users, and/or determine the nature and amount of influence a user has in propagating an advertisement through the social network. From the determined influences, the more or most influential users may be identified.

In various embodiments, the Rights Filter Service 106 is also designed to take as input a user ID and a set of content IDs, and return the subset of content IDs that the user with the particular ID is allowed to see. In various embodiments, a relational database is created for storing rights information. Each record in the relational database would store a user ID, a content ID, and whether the user was explicitly denied access to the content item. For example, if User A is not allowed to see Content B, then there could be a record that contains the ID for User A and the ID for Content B. Given a set of content IDs and a user ID, the Rights Filter Service can perform a query against the database returning all content IDs from the set that do not have a corresponding record with that ID and the user ID.

In various embodiments, the Content Merging Service 108 is designed to merge together content and advertisements from many different sources, such as the Relevant Content Service content, user uploaded content, and Relevant Advertisement Service advertisements.

The Content (and Metadata) Store 110/112 is designed to store the actual content (or metadata of content). In various embodiments, a file system is used. Given a content ID, the file system can have a set of directories whose names correspond to each character in the content ID. The first N set of characters could be used for directories, and the remaining set ignored. This enables the system to control how many items are stored in any particular directory. For example, if the system creates directories 4 levels deep, than an item with content ID 0192323 would be given the file name 0192323 and be stored in directory 0/1/9/2. Thus, the full path to the piece of content would be 0/1/9/2/0192323. The content store would return the path to the content item given a particular ID.

Given these services, when a User A views a page for a User B, the invention determines what to show User A. First, it calls the Relevant Content Service 102 to get content for User B. Next, it calls the Relevant Advertisement Service 104 to get advertisements for User B's page. The Relevant Content Service 102 content is then passed to the Rights Filter service 106 so that only content User A is allowed to see is returned. If User A is not the same as User B, then the system selects a set of content that has been uploaded by User B. This is passed to the Rights Filter so that only content that User A is allowed to see is returned. These two sets of content and the advertisement are then merged together by the Content Merging Service 108 and returned.

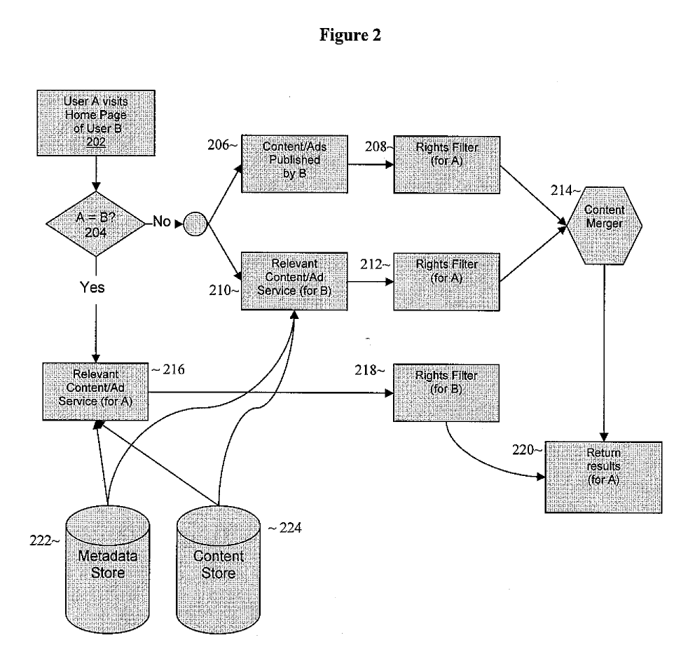

FIG. 2 illustrates advertisement selection and propagation, in the context of content publication illustrated in FIG. 1, in accordance with various embodiments of the present invention. As illustrated, for the embodiments, during operation, the process may begin at 201, with User A coming to the social network and viewing a page administered by User B. The system determines whether User A and User B are the same user (202). If User A and User B are the same user, then this means that User A is visiting his own page.

If User A is visiting his own page then the system calls the Relevant Content Service 102 and Relevant Advertisement Service 104 to determine what to show the user. The Relevant Content Service 102, in response, examines content that has been uploaded by specified users of the social network and advertisements that have been selected by specified users of the social network, and by analyzing user activity, determines what content including advertisements will be interesting for User A.

The Relevant Content Service 102 retrieves its information from a metadata store which stores information about what content has been uploaded by specified users of the social network and what content and what pages within the social network site have been viewed by specified users of the social network and what advertisements have been selected by specified users of the social network. The metadata store can be implemented in various ways, such as with a relational database in which each content item, user and home page has a unique identifier, and in which a field code indicates an action. For example, if user A uploads content B, then a record can be entered in the database indicating that user A performed action “upload” on content B. Likewise, if user C views content B, a record can be entered indicating that user C performed action “view” on content B.

The Relevant Content Service 102 also retrieves information from a Content Store 110. This stores the actual content that the metadata service refers to. The Content Store 110 can be embodied in a variety of ways, such as a set of files in a file system or a set of binary data stored within a relational database.

The Relevant Advertisement Service 104, as described above, retrieves advertisements that have been explicitly added by the user of the published page, if any. The Service also automatically delivers advertisements based on preferences of User A, User B, or both users. The Relevant Advertisement Service 104 may determine one or more advertisements using methods similar to those used by the Relevant Content Service 102, also described above, for determining content. Upon automatically determining which advertisements to display and in what format, the Relevant Advertisement Service 104 may retrieve the determined advertisements and display them in the correct positions.

Once the Relevant Content Service returns a set of content items to display, the system passes them to a Rights Filter service (209). The purpose of this service is to make sure that the content and advertisements returned (210) are content and advertisements that User A is allowed to see. The rights service can be created in any number of ways. For example, the Rights Filter could be embodied in a relational database, in which each record contains a user ID, a content ID, and a right. For example, if User A is not allowed to see Content B, then there could be a record that says User A is denied rights to view Content B. Given a content ID and a user ID, the Rights Filter service can check the database to determine whether or not the user is allowed to see the content. After the Rights Filter service has removed items that User A is not allowed to see, the resulting set of content items is returned (210).

If User A and User B are different users, then the decision process (202) moves to a different process. In this case, the system performs two operations. Similar to the step previously outlined, the system calls the Relevant Content Service 102 and Relevant Advertisement Service 104 to determine what content and advertisements to show User B (204). Note that User A is looking at User B's page. By calling the Relevant Content Service 102 and Relevant Advertisement Service 104 for User B (instead of User A), the system is displaying to User A the content and advertisements that we would normally show to User B.

The system then removes items from the result set that User A is not allowed to see (205). This is similar to what was earlier described for 203, only in this case we are determining what the system would normally show User B, but then removing content and advertisement that User A is not allowed to see.

In addition, the system shows User A items that User B has uploaded to the system (206). In this process, the system examines the Metadata Store (211) to find content that User B has created. In various embodiments, the system divides the content that User B has created into two categories: recent and not-recent content. The service for selecting a subset of User B's content selects a set of content from the recent category and a set from the not-recent category. The recency is determined by looking at the metadata associated with the content. The percentage of content that should be selected from the recent and not-recent set can be established in a variable so that the system or administrators of the system can alter the values.

In various embodiments, the techniques used for selecting content from the recent and not-recent set could include stochastic sampling or relevancy algorithms as are used by the Relevant Content Service 102 and Relevant Advertisement Service 104. Additionally, the Relevant Advertisement Service 104 for User B may be invoked to determine and retrieve one or more advertisements to show User A, as discussed above.

After the selection of a set of content and advertisements, the system passes control to the Rights Filter (207). As with (205), this process is invoked to ensure that User A is allowed to view the set of content and advertisements that are returned.

Then, the Content Merging Service merges together the content and advertisements that were selected by 204 and 206. The merging process can be embodied in a variety of forms. For example, all content/advertisements could be returned by returning the complete set of content/advertisements returned by the selection processes 204 and 206. Or, the two sets could be stochastically sampled to return a smaller set. Or, the two sets could be merged and relevance sorted to return a smaller set. Or, the two sets could be relevance sorted individually and then sampled equally. There are many other embodiments as well.

After the content/advertisements are merged, the merged content/advertisements are returned.

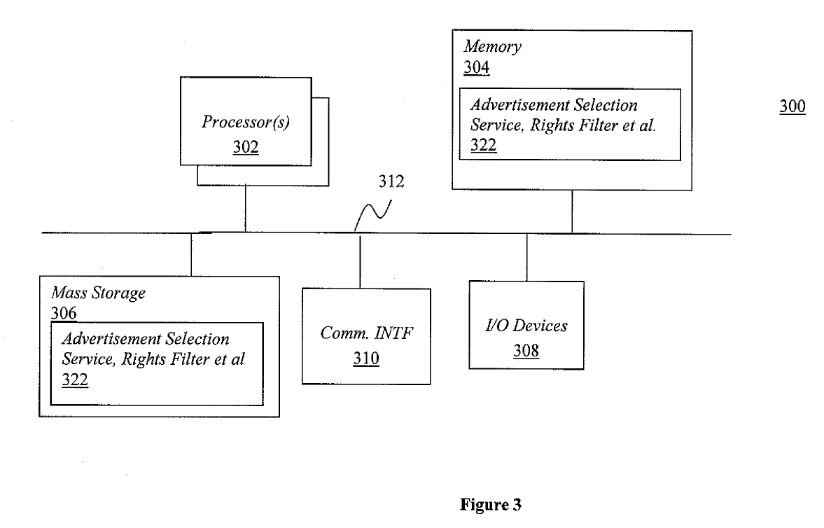

FIG. 3 illustrates an example computer system suitable for use as a client device to practice various embodiments of the present invention. As shown, computing system 300 includes a number of processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as display, keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing, in whole or in part, services 102, 104, 106 and/or 108, collectively denoted as 422. The various components may be implemented by assembler instructions supported by processor(s) 302 or high-level languages, such as C, that can be compiled into such instructions.

The permanent copy of the programming instructions may be placed into permanent storage 306 in the factory, or in the field, through, for example, a distribution medium (not shown), such as a compact disc (CD), or through communication interface 310 (from a distribution server (not shown)). That is, one or more distribution media having an implementation of the agent program may be employed to distribute the agent and program various computing devices.

The constitution of these elements 302-312 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
receiving by a computing device, from a user, a specification of an advertiser or a category of advertisements indirectly specifying a first advertisement, or a specification directly specifying the first advertisement, the first advertisement to be displayed in connection with content being published or administered by the user;
providing or enabling providing, by the computing device, a second advertisement to be displayed with content subsequently viewed by the user, based at least in part on the direct or indirect specification of the first advertisement.

2. The method of claim 1, wherein the specification comprises one or more of a position or a format of the first advertisement.

3. The method of claim 1, wherein the providing or enabling providing comprises the computing device providing the second advertisement to a client device of the user to be displayed with the content subsequently viewed by the user, the providing being based at least in part on the direct or indirect specification of the first advertisement.

4. The method of claim 1, wherein the providing or enabling providing comprises the computing device providing the specification to an advertisement provider to enable the advertisement provider to provide the second advertisement to a client device of the user to be displayed with the content subsequently viewed by the user, the providing of the second advertisement being based at least in part on the direct or indirect specification of the first advertisement.

5. The method of claim 4, wherein the advertisement provider also provides the content subsequently viewed by the user.

6. The method of claim 1, further comprising:
receiving by the computing device, response of the user to the second advertisement; and
conditionally specifying the second or a third advertisement to be displayed with the content or other content being published by the user, or distributing the second or third advertisement to another that is a friend of the user, based at least partly on the selections or response of the user.

7. The method of claim 6 further comprises tracking propagation of one or more of the advertisements through a social network comprising the user.

8. The method of claim 6 further comprises determining the nature and amount of influence of the user in propagating the advertisements through a social network comprising the user.

9. A method comprising:
receiving by a computing device, from a user, one or more preferences of the user;
providing or enabling providing, by the computing device, an advertisement to be displayed in connection with content subsequently viewed by the user, based at least in part on the intersection of one or more preferences of the user with one or more preferences of a publisher or an administrator of content or a medium which the user consumes.

10. The method of claim 9, further comprising:
receiving by the computing device, response of the user to the advertisement; and
conditionally specifying the advertisement or another advertisement to be displayed in connection with content being published by the user, or distributing the advertisement or the other advertisement to another user that is a friend of the user, based at least in part on the response of the user to the advertisement.

11. The method of claim 10 further comprises tracking propagation of one or more of the advertisements through a social network comprising the users.

12. The method of claim 10 further comprises determining the nature and amount of influence of each of one or more of the users in propagating the advertisements through a social network comprising the users.

13. A method comprising:
receiving by a computing device, from a user, a specification of an advertiser or a category of advertisements, indirectly specifying an advertisement, or a specification directly specifying the advertisement, the advertisement to be displayed in connection with content being published by the user,
providing or enabling providing, by the computing device, the advertisement to be displayed in connection with content subsequently viewed by another user that is a friend of the user, based at least in part on the specification of the advertisement.

14. The method of claim 13, further comprising:
receiving by the computing device, response of the other user to the advertisement; and
conditionally specifying the advertisement or another advertisement to be displayed in connection with content being published by the other user, or distributing the advertisement or the other advertisement to yet another user that is a friend of the other user, based at least in part on the response of the other user.

15. The method of claim 13 further comprises tracking propagation of one or more of the advertisements through a social network comprising the users.

16. The method of claim 13 further comprises determining the nature and amount of influence of each of one or more of the users in propagating the advertisements through a social network comprising the users.

17. An apparatus comprising:
at least one processor; and
storage medium coupled to the processor, having stored therein a plurality of programming instructions to be operated by the processor, the programming instructions configured to practice the method as set forth in claim 1 when the programming instructions are operated by the processor.

18. An apparatus comprising:
at least one processor; and
storage medium coupled to the processor, having stored therein a plurality of programming instructions to be operated by the processor, the programming instructions configured to practice the method as set forth in claim 9 when the programming instructions are operated by the processor.
